(19) United States
(12) Patent Application Publication
(10) Pub. No.: US 2009/0265755 A1
(43) Pub. Date: Oct. 22, 2009

(54) FIREWALL METHODOLOGIES FOR USE WITHIN VIRTUAL ENVIRONMENTS

(75) Inventors: Rick A. Hamilton, II, Charlottesville, VA (US); Robert C. McGinley, Olympia, WA (US); Brian M. O'Connell, Cary, NC (US); Clifford A. Pickover, Yorktown Heights, NY (US); Keith R. Walker, Austin, TX (US)

Correspondence Address: IBM Endicott- DeLizio Gilliam, PLLC, c/o DeLizio Gilliam, PLLC, 15201 Mason Road Suite 1000-312, Cypress, TX, 77433, US

(73) Assignee: International Business Machines Corporation, Armonk, NY (US)

(21) Appl. No.: 12/106,050

(22) Filed: Apr. 18, 2008

(51) Int. Cl. G06F 21/00

(52) U.S. Cl. 726/1

(57) ABSTRACT

In some embodiments a method comprises receiving a virtual universe request, and determining properties of the virtual universe request. The method can also comprise determining a virtual universe firewall security policy, wherein the virtual universe firewall security policy identifies allowable properties associated with the virtual universe request. The method can also include comparing the properties of the virtual universe request to the properties of the virtual universe firewall security policy, and blocking the virtual universe request based on the comparison of the virtual universe request's properties to the virtual universe firewall security policy's allowable properties.

### TECHNICAL FIELD

Embodiments of the inventive subject matter generally relate to the field of virtual universes and, more particularly, to firewall methodologies for use within virtual universes.

### BACKGROUND

Virtual universe systems allow people to socialize and interact in a virtual universe. A virtual universe (“VU”) is a computer-based simulation environment intended for its residents to traverse, inhabit, and interact through the use of avatars and other constructs. Many VUs are represented using 3-D graphics and landscapes, and are populated by many thousands of users, known as “residents.” Other terms for VUs include metaverses and 3D Internet.

### SUMMARY

In some embodiments a method comprises receiving a virtual universe request, and determining properties of the virtual universe request. The method can also comprise determining a virtual universe firewall security policy, wherein the virtual universe firewall security policy identifies allowable properties associated with the virtual universe request. The method can also include comparing the properties of the virtual universe request to the properties of the virtual universe firewall security policy, and blocking the virtual universe request based on the comparison of the virtual universe request's properties to the virtual universe firewall security policy's allowable properties.

### BRIEF DESCRIPTION OF THE DRAWINGS

The present embodiments may be better understood, and numerous objects, features, and advantages may be made apparent to those skilled in the art by referencing the accompanying drawings.

FIG. 1 is a conceptual diagram illustrating an example virtual universe environment.

FIG. 2 is a block diagram illustrating a virtual universe network including a virtual universe firewall, according to some embodiments of the invention.

FIG. 3 is a block diagram illustrating spatial divisions in a virtual universe environment.

FIG. 4 is a conceptual diagram showing how security policies can be associated with a VU region, according to some embodiments of the invention.

FIG. 5 is a flow diagram illustrating operations for a virtual universe firewall controlling inter-zone or inter-region virtual universe requests, according to some embodiments of the invention.

FIG. 6 is a conceptual diagram illustrating an example operation for a virtual universe firewall controlling inter-zone or inter-region virtual universe requests, according to some embodiments of the invention.

FIG. 7 is a flow diagram illustrating operations for a virtual universe firewall controlling intra-zone or intra-region virtual universe requests according to some embodiments of the invention.

### DESCRIPTION OF EMBODIMENT(S)

The description that follows includes exemplary systems, methods, techniques, instruction sequences and computer program products that embody techniques of the present inventive subject matter. However, it is understood that the described embodiments may be practiced without these specific details. In other instances, well-known instruction instances, protocols, structures and techniques have not been shown in detail in order not to obfuscate the description.

### Introduction

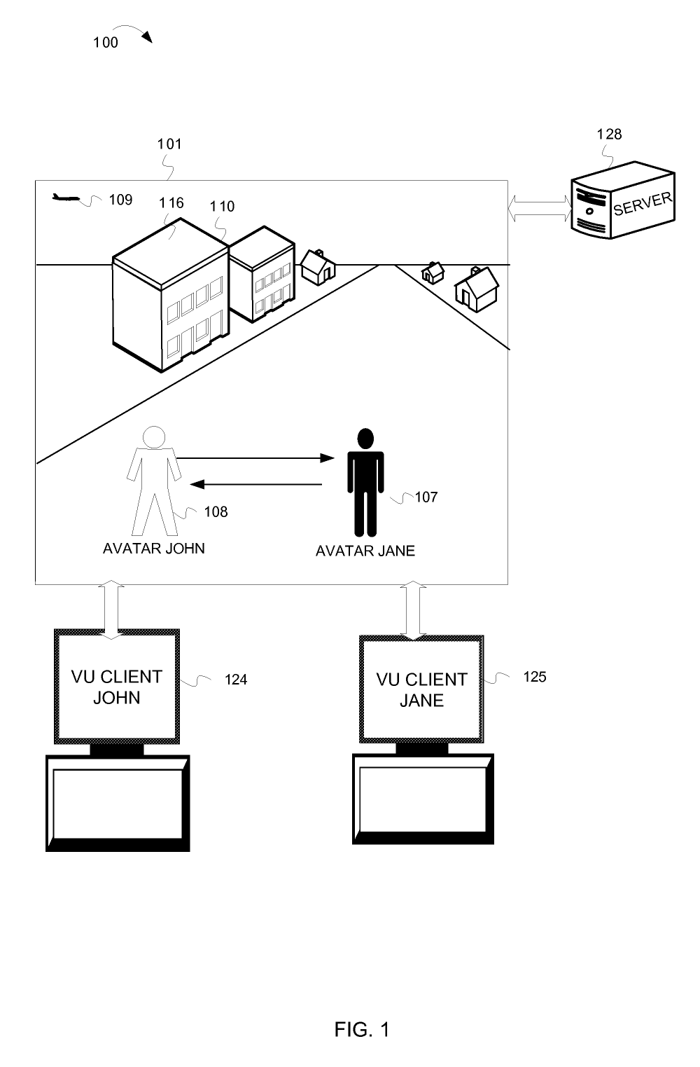

Virtual universes are becoming increasingly popular for social and business use. FIG. 1 is a conceptual diagram illustrating an example virtual universe environment. In FIG. 1, the virtual universe environment includes a server 128 and clients 124 & 125. The server 128 includes logic for presenting and managing a virtual universe 101. The clients 124 & 125 include logic that enables users to view the virtual universe 101, control avatars, and otherwise interact with the virtual universe 101. The virtual universe 101 includes various objects, such as avatars 107 & 108, buildings 110 & 116, modes of transportation 109, etc. In the virtual universe 100, users can use their avatars to interact with other avatars and with their surroundings, buy items from stores, visit buildings, teleport to other parts of the virtual universe, move objects, participate in activities, etc.

While VUs have vast business and social benefits, they also have security risks. Because virtual universes (VUs) allow avatars to move about (e.g., teleport), carry objects, and perceive objects, avatars may engage in questionable activities, such as gaining unauthorized access to business data, absconding with business property, eavesdropping, etc. Given these security concerns, VU users may wish to restrict access to VU locations (e.g., buildings, meeting rooms, etc.), VU objects (e.g., documents), VU capabilities (e.g., teleport, chat, object possession), and other VU features. For example, a VU user may wish to restrict access to confidential documents, prohibit unauthorized employees from teleporting into a conference room, prohibit email transmissions during work hours within business regions, or prohibit avatars from looking into a conference room when a meeting is in session. Similarly, VU users may not want to receive various notifications or teleport requests from unknown users. Some embodiments of the inventive subject matter address these issues by enabling VU users to place restrictions on communications, movements, perceptions, and other VU features.

### Architectures and Operating Environments

This section describes an example of the architecture for a virtual universe network with firewalls and presents aspects of some embodiments.

### VU Network Architecture

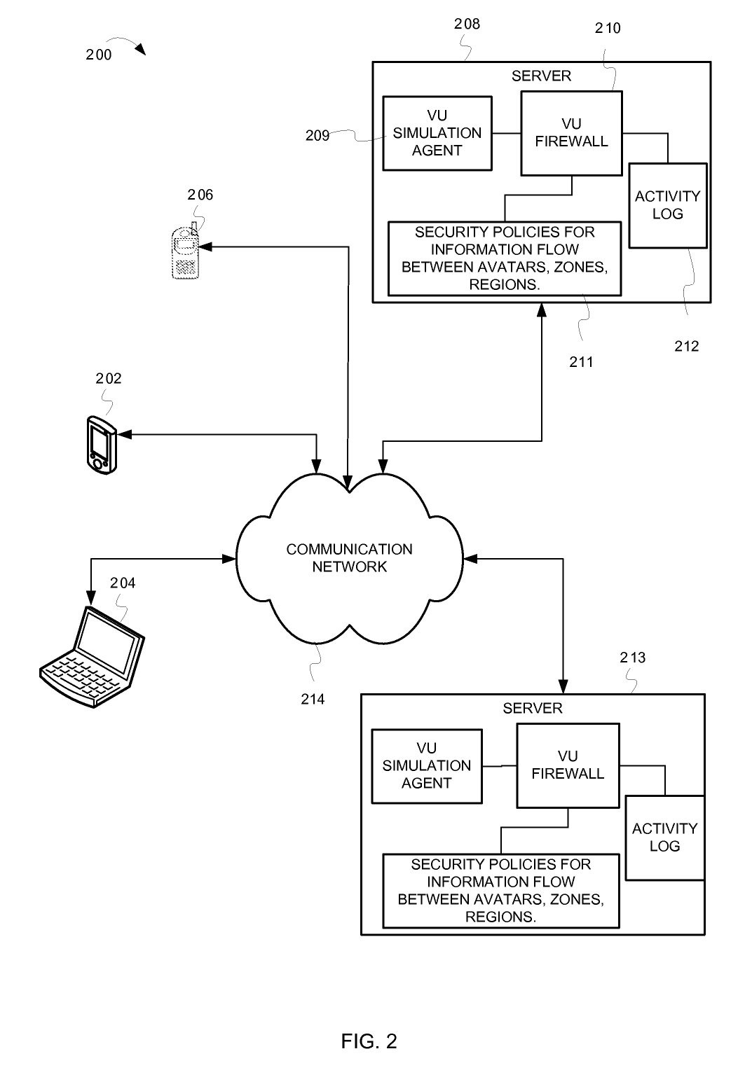

FIG. 2 is a block diagram illustrating a virtual universe network including a virtual universe firewall, according to some embodiments of the invention. As shown in FIG. 2, a virtual universe network 200 includes a plurality of servers 208 & 213. Each server (e.g., 208) includes a virtual universe simulation agent 209 which is connected to a virtual universe firewall 210. The virtual universe firewall 210 is also connected to a repository of security policies 211 and an activity log 212. The VU firewall 210 can process requests from the VU simulation agent 209 or other VU simulation agents and components. The requests can include teleport requests, teleport invitations, email, chat requests, requests to pick-up objects, requests to view data, etc. The VU firewall 210 can determine whether to block requests based on the security policies 211. The security policies can apply to zones, regions, users, or any other geographic space or entity. Additionally, the VU firewall can record operations in the activity log 212. The security policies 212 and activity log 212 can reside inside or outside the virtual universe firewall 210.

The virtual universe network 200 also includes multiple clients, which can be in the form of PDAs 202, personal computers 204, cellular phones 206, etc. The virtual universe clients can use browsers or other software to present virtual universes.

The servers 208 & 213 and the clients 202, 204 & 206 are connected to a communication network 214. The communication network 214 can include any technology suitable for passing communication between the clients and servers (e.g., Ethernet, 802.11n, SONET, etc.). Moreover, the communication network 214 can be part of other networks, such as cellular telephone networks, public-switched telephone networks, cable television networks, etc.

Any of the components of the VU network 200 and any other embodiments described herein can include computer program products, or software, that may include a machine-readable medium having stored thereon instructions, which may be used to program a computer (or other electronic device(s)) to perform a process according to embodiments, whether presently described or not, as every conceivable variation is not enumerated herein. A machine readable medium includes any mechanism for storing or transmitting information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions. In addition, embodiments may be embodied in an electrical, optical, acoustical or other form of propagated signal (e.g., carrier waves, infrared signals, digital signals, etc.), or wireline, wireless, or other communications medium.

### Regions, Zones, Buildings, and Firewall Rules

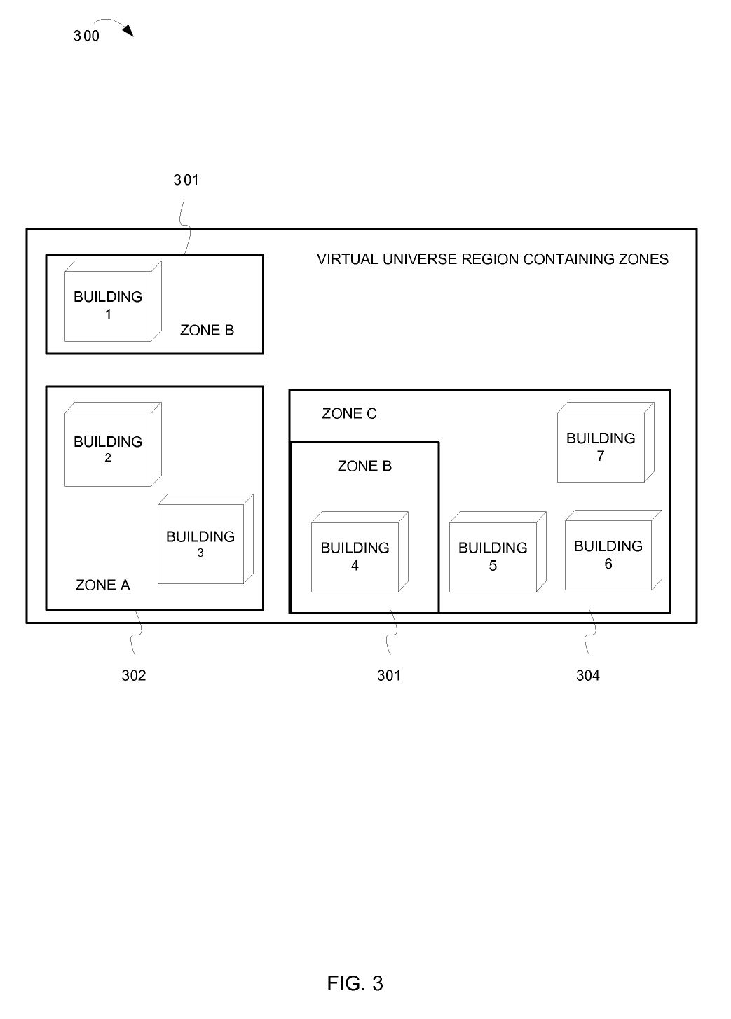

FIG. 3 is a block diagram illustrating spatial divisions in a virtual universe. In some embodiments, VUs can be spatially divided into different spaces, such as regions, zones, buildings, rooms, etc. Regions can represent the largest space, while zones can be smaller areas within regions. These spaces may be defined using map coordinates in the shape of rectangles (((x1, y1), (x2, y2), (x3, y3), (x4, y4)), circles (center at (x, y), radius=z), or in other ways using geometric principles. The spaces can be three-dimensional and they can be shaped as buildings, rooms, islands etc.

In FIG. 3, a virtual universe region 300 is divided into three distinct zones: zone A (302), zone B (301), and zone C (304). Each of these zones contains buildings. For example, zone B (301) contains building 1, zone A (302) contains buildings 2 and 3, and zone C (304) contains buildings 5, 6, and 7. As shown, the zone shapes need not be connected to define a single zone (i.e., a plurality of shapes can define a single zone). For example, zone B is defined by two shapes 301, where one of the shapes 301 resides inside zone C (304). Thus, shapes can overlap. Moreover, any of a zone's shapes can include more shapes (e.g., building 4 resides in a portion of zone B, which is contained within zone C).

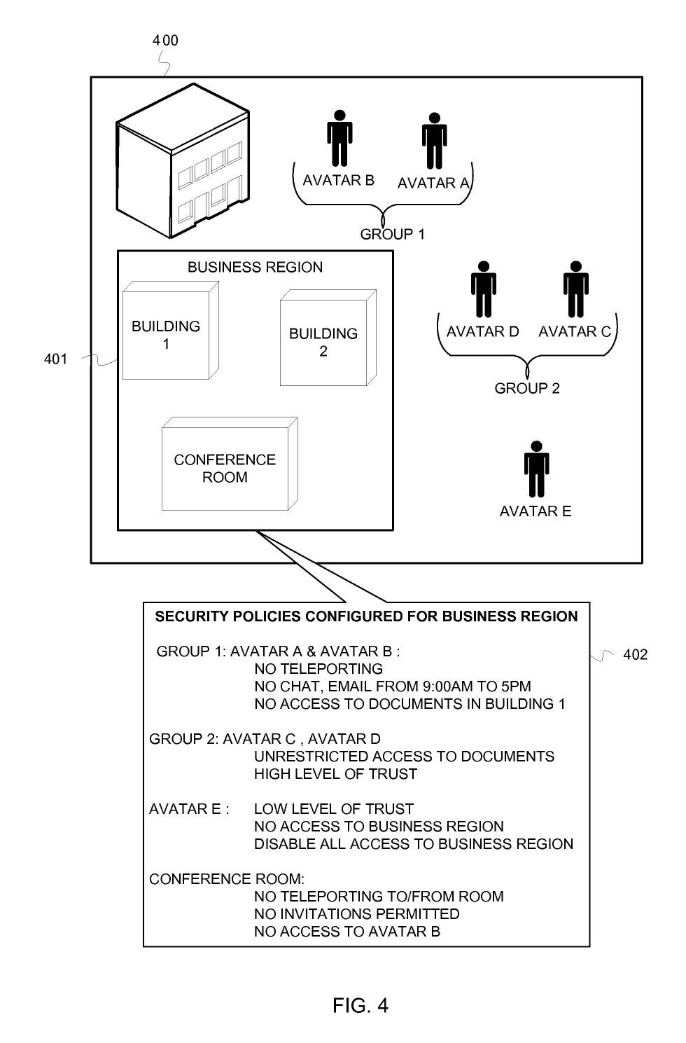

While FIG. 3 describes spatial divisions in VUs, the discussion continues with a description about how the spatial divisions can be associated with firewall rules. FIG. 4 is a conceptual diagram showing how security policies can be associated with a VU region, according to some embodiments of the invention. FIG. 4 depicts a virtual universe 400 including various objects. In FIG. 4, a business region 401 is part of the virtual universe 400 and contains building 1, building 2, and a conference room. The virtual universe 400 also contains avatars A and B which together form Group 1, avatars C and D which together form Group 2 and avatar E.

FIG. 4 shows some example policies 402 available to a region owner for controlling interactions within the business region 401. The region owner may set security policies based any suitable criteria. For example, in FIG. 4, the security policy 402 indicates: 1) group 1 (avatars A and B) has no teleporting rights and no access to documents in building 1, 2) group 2 (avatars C and D) has unrestricted access to all documents in the business region 401, and 3) avatar E is not trusted and has absolutely no access to the business region 401 and documents associated with the business region 401 (e.g., documents residing in a virtual file cabinet in building 1).

In some embodiments, zones themselves may be configured with security policies. These security policies can be distinct from other zones within the same region. For example, referring to FIG. 4, the security policies 402 indicate that the conference room has special security policies. According to the security policies 402, avatar B is restricted from accessing the conference room although he is welcome within the business region. Once inside the conference room, no avatar may send or receive any requests or invitations (teleporting, email, chat, etc). The security policies 402 also do not allow any avatar to teleport into or out of the conference room.

Security policies may also have time-based restrictions. For example, VU security policies can enforce limitations such as: 1) an avatar or group of avatars may have access to a building and to documents only during work hours, 2) avatars may be restricted from entering the business zone on weekends and holidays, 3) avatars may not be allowed to enter a business region if their shift has not started, and 4) the policies may force an avatar to instantly teleport to a region (from anywhere in the virtual universe) after the avatar's work shift starts.

### VU Requests and Firewall Rules

Security policies and firewall rules can be configured for all types of requests including communications, visual access, physical access, and data. Examples of communication based security policies are: 1) sending emails to non-work contacts during work hours may be prohibited, 2) email and chat communication may be disabled in the conference room, 3) sending or receiving teleport requests in the business region may be prohibited, and 4) chat or teleport invitations from users outside the contact list may be blocked.

Security policies may also be configured to restrict visual access. For example, VU security policies can enforce limitations like: 1) an avatar may choose to prohibit peeking inside its virtual home, 2) windows can turn opaque when avatars try to look inside a virtual home or office, 3) looking into a conference room when a meeting is in session may be prohibited, 4) suspicious users may be prohibited from looking into a business region, and 5)to protect confidential documents, the virtual file cabinet may be invisible to avatars who do not have access to the documents.

Firewall rules and security policies can be configured for physical access into a VU area. Some examples of these policies are: 1) employees may be restricted from entering a conference room once a meeting starts, 2) unauthorized users may be prohibited from entering a business zone without being validated, 3) a user may not want people outside his/her “friend” list to enter his/her virtual home, 4) avatars may be forbidden from leaving the building before the work shift ends, 5) teleporting in and out of a conference room may be prohibited, 6) low level employees may be restricted from moving into high security sections of the business region, 7) new employees may be restricted from entering the business region until their shift begins, 8) only high level employees (CEO, President, etc) may be allowed to teleport into the business region, 9) flying over a high security zone may be forbidden, and 10) avatars may be prohibited from leaving the region if there is a blizzard in the virtual city.

Likewise, security policies can be configured for data (e.g., documents, audio/video files, etc). Examples of security policies configured for documents include: 1) only high level employees may access confidential documents, 2) emailing confidential documents may be prohibited, 3) accessing business region documents from outside the region may be prohibited, 4) confidential documents may have ‘read-only’ access, and 5) copying and pasting sections of confidential documents may be disabled. Firewall rules may also be configured for audio/video files and can include policies like: 1) accessing external audio/video files (not part of the business region) from within the region may be prohibited, 2) accessing business region audio/video files from outside the region may be restricted, 3) emailing audio/video files may be prohibited, 4) making copies of the file may be restricted and 5) only the creator of the file may be allowed to modify it.

### VU Firewall Operations

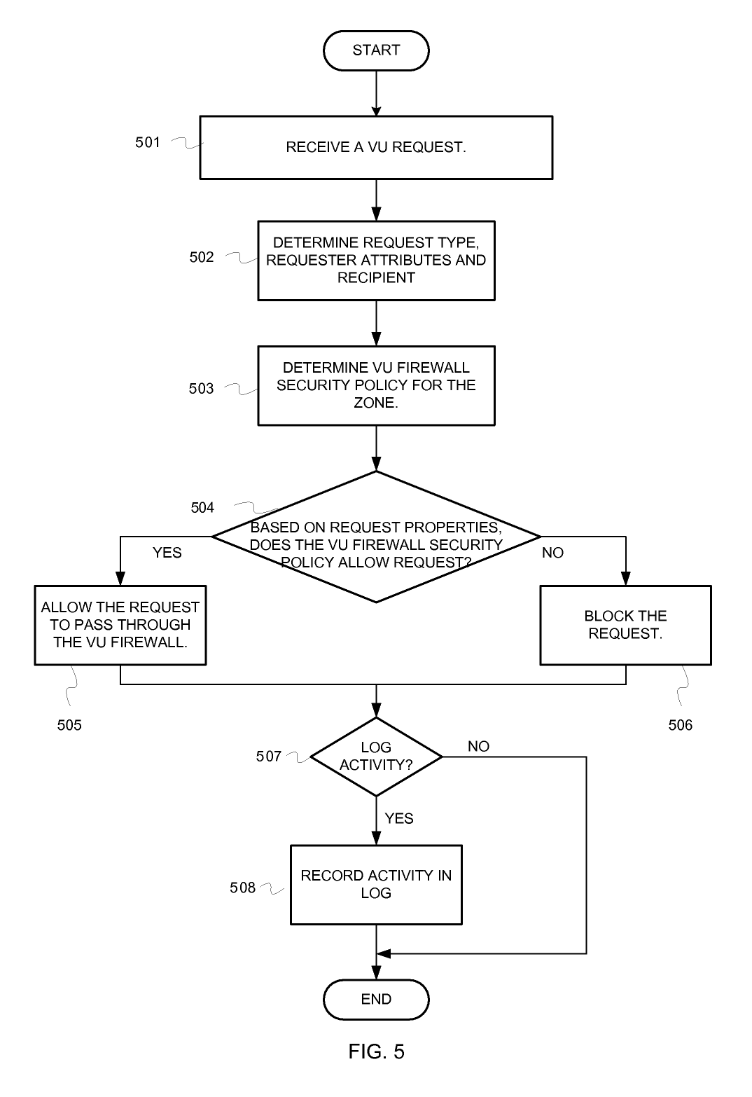

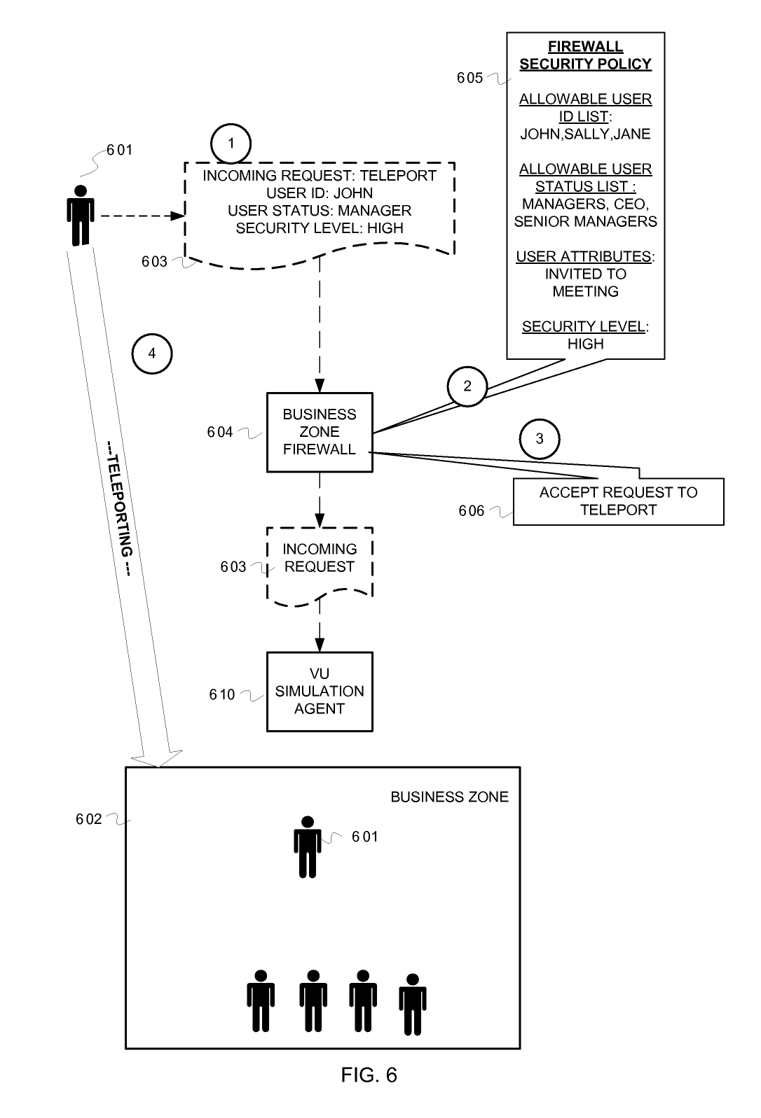

FIG. 5 is a flow diagram illustrating operations for a virtual universe firewall controlling inter-zone or inter-region virtual universe requests, according to some embodiments of the invention. In some embodiments, the operations shown in FIG. 5 are not limited to zones and regions, as they can be used for controlling requests between buildings or other VU spaces of the same type. The following discussion will refer to FIGS. 5 and 6 together, as FIG. 6 provides conceptual support for the flow 500. The flow 500 begins at block 501.

At block 501, a VU firewall receives a virtual universe request destined for a VU space rendered by a VU simulation agent. FIG. 6 illustrates this concept. In FIG. 6, the firewall 604 receives an avatar's request 603 for permission to teleport into a business zone 602. The VU firewall 604 can process all requests associated with the business zone 602. The virtual universe requests can include email, invitations to teleport, requests to teleport, voice messages, etc. Referring back to FIG. 5, the flow continues at block 502.

At block 502, the virtual universe firewall determines properties associated with the VU request. The properties can include VU request type, attributes of the requester, intended recipient of the request, etc. The VU request types can include email, chat messages, voice communication, teleport requests/invitations, visibility requests, document access, physical access into a building, zone, region, etc. Requester attributes can include avatar name, user status, position in the organizational hierarchy (e.g., not part of the organization, employee, manager, CEO, etc.), security level, avatar's current location, etc. In FIG. 6, the request 603 contains information about the avatar, including user id, status, and security level. In FIG. 5, the flow continues at block 503.

At block 503, the virtual universe firewall uses a repository of firewall policies and determines the security policy associated with a given VU space. This is illustrated in FIG. 6 (see step 2), where the virtual universe firewall 604 checks the requester attributes against the security policies 605. Security policies can include restrictions such as restricted access to a zone, restricted visibility of a zone (e.g., objects can be obscured from view for avatars), no access into a business region before 9:00 am after 5:00 pm, no teleporting into the conference room when a meeting is in progress, etc. The virtual universe firewall 604 may have different policies to handle different incoming and outgoing requests. For example, the policy might dictate all outgoing requests be blocked to prevent leaking of confidential information, metadata in files may be monitored to ensure that sensitive information is not be misused, etc. As for incoming requests, the security policies can block incoming teleporting and chat requests during business hours to prevent employees from wasting time, etc. The flow then continues at block 504.

At block 504, the virtual universe firewall decides whether to allow or block the request based on the request properties (e.g., type of request, requester attributes, and the intended recipient of the request, etc.). For example, the policy may be configured such that only high-level employees (managers, CEO, etc.) have access to confidential information and can accept teleport invitations. In some embodiments, the security policy considers criteria other than the request, requester attributes, and intended recipient. For example, the security policy may consider time, VU space from which request originates, VU environment factors (e.g., weather in the VU), etc. In some embodiments, instead of blocking the request altogether, the VU firewall can delay delivery, based on the security policy. If the VU firewall approves the request, the flow continues at block 505. Otherwise, flow continues at block 506.

At block 505, the virtual universe firewall accepts and passes the request through to the virtual universe simulation agent, which completes the request. This is shown in FIG. 6 where the virtual universe firewall 604 accepts the teleport request 603 (step 3) and then relays this request 603 to the virtual universe simulation agent 610. The virtual universe simulation agent 610 then teleports the avatar 601 (requester) into the business zone 602 (step 4). The flow then continues at block 507.

At block 506, the virtual universe firewall denies the request. Hence, the virtual universe simulation agent does not complete the request. Once the virtual universe firewall makes a decision to either allow or block the request, the flow continues at block 507.

At block 507, the virtual universe firewall records details of the activity in an activity log. In some embodiments, the VU firewall records activities based on configurations set by the region owner. For example, the region owner can limit logging to chat and message accesses and teleport requests. The region owner can also set configurations to log avatars' mode (e.g., walking, flying, teleporting, etc) and time of entry into an area, time of exit from an area, file accesses from inside and outside a region and status of a request (whether accepted or blocked). In some embodiments, actual chat text may be recorded (for example in regions of high security). If the region owner configures the firewall to log activity, control passes to block 508, where the VU firewall updates the activity log and the flow ends. The region owner may also choose not to record any activity. In that case, the flow ends without any logging operations.

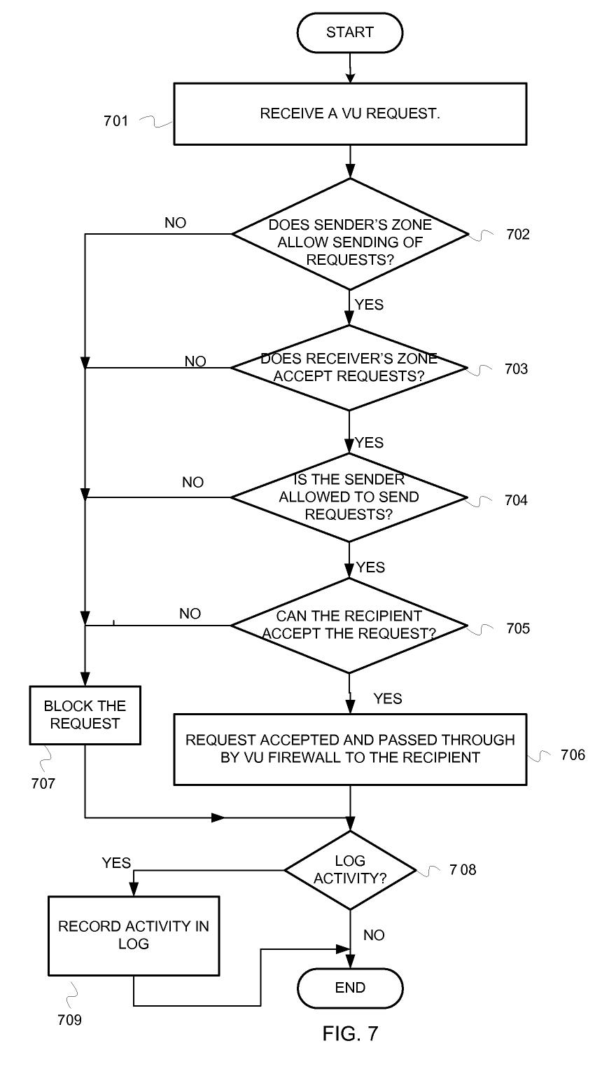

FIG. 7 is a flow diagram illustrating operations for a virtual universe firewall controlling intra-zone or intra-region virtual universe requests according to some embodiments of the invention. In this example, the VU firewall is a regional firewall and controls communication between zones within the region. Because different zones in the same region can be configured with different policies, the regional firewall checks policies associated with the sender's zone and the receiver's zone before it makes a decision about blocking the request.

At block 701, the virtual universe simulation agent receives a virtual universe request. The virtual universe request can include email, invitations to teleport, requests to teleport, voice messages, etc. The virtual universe firewall determines the type of request (voice, email, teleport invitations, etc) and the sender and receiver attributes (avatar id, current location, security level, etc). The flow continues at block 702.

At block 702, the virtual universe firewall checks the security policies associated with the sender's zone. For example, the associated security policy can be configured to allow sending requests during a certain time interval, prohibit sending requests, etc. If the virtual universe firewall determines that the sender's zone permits sending of requests, then the flow continues at block 703. Otherwise, the flow continues at block 707.

At block 703, the virtual universe firewall checks the security policies associated with the receiver's zone. For example, the associated security policy may be configured to allow receiving requests during a certain time period, ban requests originating from outside the region, ban incoming teleportation invitations, etc. If the virtual universe firewall determines that the receiver's zone accepts requests of the incoming request type, then the flow continues at block 704. Otherwise, the flow continues at block 707.

At block 704, the virtual universe firewall checks the security policies associated with the sender's avatar. For example, the sender may be a low level employee in the organization and sending teleport invitations may be prohibited, the sender may be trying to email a confidential document outside the permitted area or might be trying to enter a highly restricted area. If the virtual universe firewall determines that the security policy associated with sender allows it to send the request, then the flow continues at block 705. Otherwise, the flow continues at block 707.

At block 705, the virtual universe firewall checks the security policies associated with the receiver's avatar. For example, the receiver may be in a conference and receiving invitations may be prohibited, the receiver may not want to receive messages from avatars not on its contact list etc. If the virtual universe firewall determines that the security policy associated with receiver allows it to accept requests of the incoming request type, then the flow continues at block 706. Otherwise the flow continues at block 707.

At block 706, the virtual universe firewall accepts and passes the request through to the virtual universe simulation agent. The VU simulation agent completes this request. The flow then continues at block 708.

At block 707, the virtual universe firewall blocks the request. Therefore, the virtual universe simulation agent does not complete the request. Once the VU firewall accepts or rejects the request, the flow continues at block 708.

At block 708, the virtual universe firewall records details of the activity in an activity log. In some embodiments, the VU firewall records activities based on configurations set by the region owner. The region owner can limit logging to chat and message accesses, teleport requests, request status and other such incidents based on the type of information being handled in the area, the security level associated with the area, avatars, etc. If the region owner configures the firewall to log activity, control passes to block 709 where the VU firewall updates the activity log and the flow ends. The region owner may also choose not to record any activity. In that case, the flow ends without any logging operations.

### CONCLUSION

While the embodiments are described with reference to various implementations and exploitations, these embodiments are illustrative and the scope of the inventive subject matter is not limited to them. In general, techniques for virtual universe firewalls are described herein and may be implemented with facilities consistent with any hardware system. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A method comprising:
receiving a virtual universe request;
determining properties of the virtual universe request;
determining a virtual universe firewall security policy, wherein the virtual universe firewall security policy identifies allowable properties associated with the virtual universe request;
comparing the properties of the virtual universe request to the properties of the virtual universe firewall security policy;
blocking the virtual universe request based on the comparison of the virtual universe request's properties to the virtual universe firewall security policy's allowable properties.

2. The method of claim 1, wherein the virtual universe request includes any one or more of a teleport request, a document access request, a visual access request, a physical access request and a communication request.

3. The method of claim 1, wherein the properties of the virtual universe request include one or more of type of the virtual universe request, attributes of the virtual universe request, location of a requester associated with the virtual universe request, and attributes of the requestor.

4. The method of claim 1, wherein the properties of the virtual universe request indicate an avatar identifier, current location of an avatar in a virtual universe, and security level of a requester associated with the virtual universe request.

5. The method of claim 1, wherein virtual universe firewall security policies apply to any one or more avatars and areas within the virtual universe including islands, regions, zones, buildings, and rooms.

6. The method of claim 1, wherein the virtual universe firewall security policies include one or more time-based policies, location-based policies, avatar-based policies, and request based policies.

7. The method of claim 1, further comprising;
logging information about the virtual universe request, wherein the information includes one or more of virtual universe request type, virtual universe request attributes, content of the email and chat communication, and requester attributes.

8. An apparatus comprising:
a virtual universe simulation agent configured to present a virtual universe; and
a virtual universe firewall configured to receive a virtual universe request, to determine properties of the virtual universe request, to determine a virtual universe firewall security policy, wherein the virtual universe firewall security policy identifies allowable properties associated with the request, the virtual universe firewall also configured to compare the properties of the virtual universe request to the properties of the virtual universe firewall security policy, and to block the virtual universe request based on the comparison of the virtual universe request's properties to the virtual universe firewall security policy's allowable properties.

9. The apparatus of claim 8, wherein the virtual universe firewall is configured to receive requests which include any one or more of teleport request, document access request, visual access request, physical access request, and communication request.

10. The apparatus of claim 8, wherein the virtual universe firewall is further configured to receive requests with properties including any one or more of type of the virtual universe request, attributes of the virtual universe request, location of a requester associated with the virtual universe request, and attributes of the requester.

11. The apparatus of claim 8, wherein the properties of the virtual universe request indicate an avatar identifier, current location of an avatar in a virtual universe, and security level of a requester associated with the virtual universe request.

12. The apparatus of claim 8, wherein virtual universe firewall is configured to use virtual universe firewall security policies which apply to any one or more avatars and areas within the virtual universe including islands, regions, zones, buildings, and rooms.

13. The apparatus of claim 8, wherein the virtual universe firewall security policies include one or more time-based policies, location-based policies, avatar-based policies, and request based policies.

14. The apparatus of claim 8, further comprising;
an activity log configured to store information about the virtual universe request, wherein the information includes one or more of a virtual universe request type, virtual universe request attributes, email content, chat content, and requester attributes.

15. One or more machine-readable media having stored therein a program product, which when executed a set of one or more processor units causes the set of one or more processor units to perform operations that comprise:
receiving a virtual universe request;
determining properties of the virtual universe request;
determining a virtual universe firewall security policy, wherein the virtual universe firewall security policy identifies allowable properties;
comparing the properties of the virtual universe request to the properties of the virtual universe firewall security policy;

16. The one or more machine-readable media of claim 15, wherein the virtual universe request includes any one or more of teleport request, document access request, visual access request, physical access request, and communication request.

17. The one or more machine-readable media of claim 15, wherein properties of the virtual universe request comprise any one or more of type of the virtual universe request, attributes of the virtual universe request, location of a requester associated with the virtual universe request, and attributes of the requester including an avatar identifier, current location of an avatar in a virtual universe, and security level of the requester associated with the virtual universe request.

18. The one or more machine-readable media of claim 15, wherein the virtual universe firewall security policies apply to any one or more avatars and areas within the virtual universe including islands, regions, zones, buildings, and rooms.

19. The one or more machine-readable media of claim 9, wherein the virtual universe firewall security policies include one or more time-based policies, location-based policies, avatar-based policies, and request based policies.

20. The one or more machine-readable media of claim 15, wherein the operations further comprise:
logging information about the virtual universe request, wherein the information includes one or more of virtual universe request type, virtual universe request attributes, content of communication.
